(19) United States
(12) Patent Application Publication
(10) Pub. No.: US 2026/0346729 A1
(43) Pub. Date: Nov. 5, 2026

(54) STATION BUILDING AUXILIARY POWER SOURCE DEVICE AND ELECTRIC POWER SUPPLY SYSTEM

(71) Applicant: Mitsubishi Electric Corporation, Chiyoda-ku, Tokyo (JP)

(72) Inventors: Toshiaki TAKEOKA, Tokyo (JP); Takeshi TANAKA, Tokyo (JP); Yoichi FUKUDA, Tokyo (JP)

(73) Assignee: Mitsubishi Electric Corporation, Chiyoda-ku, Tokyo (JP)

(21) Appl. No.: 19/485,940

(22) PCT Filed: May 24, 2023
(86) PCT No.: PCT/JP2023/019275

§ 371 Date: Nov. 19, 2025

(51) Int. Cl. B60L 7/16; B60L 55/00; B60M 3/06

(52) U.S. Cl. CPC B60L 7/16; B60L 55/00; B60M 3/06; B60L 2200/26; B60L 2210/10; B60L 2210/40

(57) ABSTRACT

A station building auxiliary power source device includes a power converter and a power conversion controller. The power converter converts regenerated electric power supplied from an electric railway vehicle into electric power for supply to station building equipment and surrounding equipment, and outputs the converted electric power. The power conversion controller monitors a voltage of a railway power supply line and controls the power converter in accordance with the voltage. When an output power of the power converter is larger than a power consumption of the station building equipment, the output power is supplied to the station building equipment and the surrounding equipment via an equipment power supply line. When an output power of the power converter is equal to or smaller than the power consumption of the station building equipment, the output power is supplied to the station building equipment via the equipment power supply line.

### CROSS-REFERENCE TO RELATED APPLICATIONS

This application is the United States National Phase under 35 U.S.C. § 371 of PCT International Patent Application No. PCT/JP2023/019275, filed on May 24, 2023, the disclosure of which is hereby incorporated by reference herein in its entirety.

### TECHNICAL FIELD

The present disclosure relates to a station building auxiliary power source device and an electric power supply system.

### BACKGROUND ART

Regenerated electric power generated during braking of an electric railway vehicle is supplied to station building equipment such as air conditioning devices, lighting devices, and elevating machines arranged in a station building, as well as to an in-vehicle device of this electric railway vehicle, other electric railway vehicles running nearby, and the like. An example of an electric power supply system that supplies electric power to station building equipment is disclosed in Patent Literature 1. The supply power adjustment system disclosed in Patent Literature 1 converts surplus regenerated electric power as a result of non-consumption by a running electric vehicle into alternating-current power and supplies the alternating-current power to multiple station buildings with adjustment in an amount of electric power supplied to each station building.

### CITATION LIST

### Patent Literature

Patent Literature 1: Unexamined Japanese Patent Application Publication

### SUMMARY OF INVENTION

### Technical Problem

The supply power adjustment system disclosed in Patent Literature 1 monitors voltage values at station buildings far from a substation and adjusts the amount of power supplied to each station building in response to a voltage drop due to, for example, a sudden increase in power usage at station building equipment. However, when power consumption at each station building is small, surplus regenerated electric power cannot be consumed, and thus effective utilization of surplus regenerated electric power cannot be achieved.

The present disclosure is made in view of the aforementioned circumstances, and an objective of the present disclosure is to provide a station building auxiliary power source device and an electric power supply system that enable consumption of regenerated electric power even in the case of occurrence of fluctuation in power consumption by station building equipment.

### Solution to Problem

To achieve the aforementioned objective, a station building auxiliary power source device according to the present disclosure is to be connected to a railway power supply line connecting, to an electric railway vehicle, a railway substation to supply electric power to the electric railway vehicle, and an equipment power supply line connecting a power substation to station building equipment and surrounding equipment. The station building equipment is arranged in a station building and is to consume electric power, the surrounding equipment is arranged outside the station building and is to consume electric power, and the power substation is to supply electric power to the station building equipment and the surrounding equipment. The station building auxiliary power source device includes a power converter and a power conversion controller. The power converter converts regenerated electric power supplied from the electric railway vehicle via the railway power supply line into electric power for supply to the station building equipment and the surrounding equipment, and outputs the converted electric power. The power conversion controller monitors a voltage of the railway power supply line and controls the power converter in accordance with the voltage of the railway power supply line. When an output power of the power converter is larger than a power consumption of the station building equipment, the output power of the power converter is supplied to the station building equipment and the surrounding equipment via the equipment power supply line, and when the output power of the power converter is equal to or smaller than the power consumption of the station building equipment, the output power of the power converter is supplied to the station building equipment via the equipment power supply line.

### Advantageous Effects of Invention

The station building auxiliary power source device according to the present disclosure is connected to the equipment power supply line that connects the power substation to the station building equipment and the surrounding equipment. When the output power of the power converter included in the station building auxiliary power source device is larger than the power consumption of the station building equipment, the output power of the power converter is supplied to the station building equipment and the surrounding equipment via an equipment power supply line. This configuration enables consumption of regenerated electric power even in the case of occurrence of fluctuation in power consumption by the station building equipment.

### BRIEF DESCRIPTION OF DRAWINGS

FIG. 1 is a block diagram illustrating configuration of an electric power supply system according to Embodiment 1 of the present disclosure;

FIG. 2 is a block diagram illustrating hardware configuration of a station building auxiliary power source device according to Embodiment 1;

FIG. 3 is a flowchart illustrating an example operation of regenerative power supply performed by the station building auxiliary power source device according to Embodiment 1;

FIG. 4 illustrates an example of electric power supply from the electric power supply system according to Embodiment 1 to station building equipment and surrounding equipment;

FIG. 5 illustrates an example of output voltage of the station building auxiliary power source device according to Embodiment 1;

FIG. 6 is a block diagram illustrating configuration of an electric power supply system according to Embodiment 2;

FIG. 7 is a flowchart illustrating an example operation of regenerative power supply performed by a station building auxiliary power source device according to Embodiment 2;

FIG. 8 illustrates an example of electric power supply from the electric power supply system according to Embodiment 2 to station building equipment and surrounding equipment;

FIG. 9 illustrates another example of the electric power supply from the electric power supply system according to Embodiment 2 to the station building equipment and the surrounding equipment;

FIG. 10 is a block diagram illustrating configuration of an electric power supply system according to Embodiment 3;

FIG. 11 is a flowchart illustrating an example operation of regenerative power supply performed by the electric power supply system according to Embodiment 3;

FIG. 12 illustrates an example of output voltage of each station building auxiliary power source device according to Embodiment 3;

FIG. 13 is a block diagram illustrating configuration of a first modified example of the electric power supply system according to the embodiments;

FIG. 14 is a block diagram illustrating configuration of a second modified example of the electric power supply system according to the embodiments;

FIG. 15 is a block diagram illustrating configuration of a third modified example of the electric power supply system according to the embodiments; and

FIG. 16 is a block diagram illustrating a modified example of the hardware configuration of the station building auxiliary power source device according to the embodiments.

### DESCRIPTION OF EMBODIMENTS

A station building auxiliary power source device and an electric power supply system according to embodiments of the present disclosure are described in detail below with reference to the accompanying drawings. In the drawings, the components identical or corresponding to each other are assigned the same reference sign.

### Embodiment 1

A station building auxiliary power source device and an electric power supply system according to Embodiment 1 are described using, as examples, a station building auxiliary power source device that receives supply of regenerated electric power from an electric railway vehicle of a direct-current feeding system and supplies electric power to station building equipment and surrounding equipment and an electric power supply system including the station building auxiliary power source device.

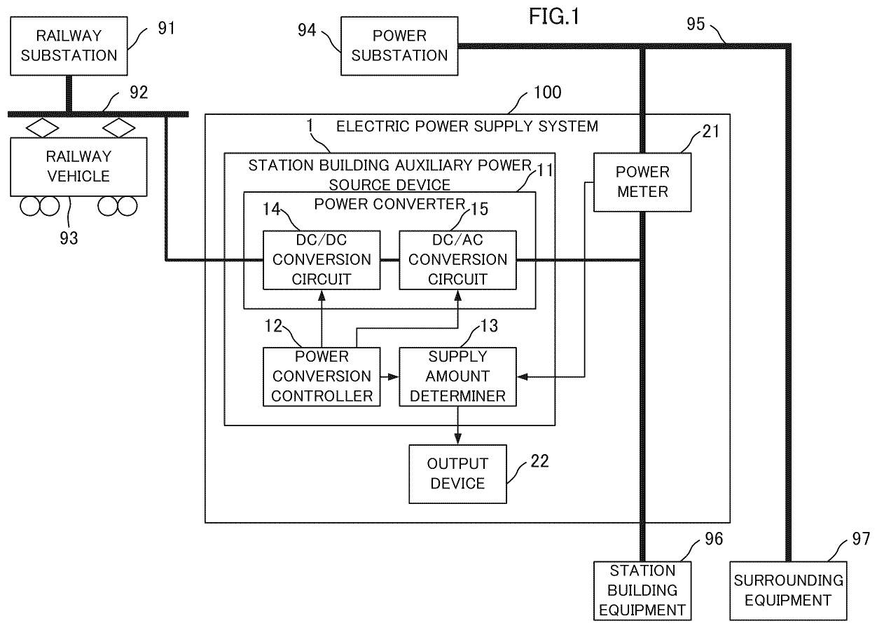

An electric power supply system 100 illustrated in FIG. 1 is connected to a railway power supply line 92 that connects a railway substation 91 to a railway vehicle 93 that is an electric railway vehicle, and to an equipment power supply line 95 that connects a power substation 94 to station building equipment 96 and surrounding equipment 97. The electric power supply system 100 converts regenerated electric power supplied from the railway vehicle 93 via the railway power supply line 92 into electric power for supply to the station building equipment 96 and the surrounding equipment 97, and outputs the converted electric power.

The railway substation 91 supplies direct-current power to the railway vehicle 93 via the railway power supply line 92. The railway vehicle 93 accelerates by driving an electric motor with electric power obtained from the railway substation 91 via the railway power supply line 92. The railway vehicle 93 outputs, to the railway power supply line 92, electric power generated by the electric motor that functions as an electric generator during braking. The electric power output from the railway vehicle 93 to the railway power supply line 92 is supplied to non-illustrated other railway vehicle and a station building auxiliary power source device 1 that is included in the electric power supply system 100.

The power substation 94 supplies alternating-current power to the station building equipment 96 that is arranged in a station building and that consumes electric power, and to the surrounding equipment 97 that is arranged outside the station building and that consumes electric power. The station building equipment 96 is electrical equipment that is arranged in the station building and that consumes electric power, such as air conditioning devices, lighting devices, elevating machines, and ticket gates. The surrounding equipment 97 is electrical equipment that is arranged in a commerce facility around a station and that consumes electric power, such as air conditioning devices, lighting devices, and elevating machines.

The equipment power supply line 95 is a power line capable of bi-directional power propagation. In detail, the equipment power supply line 95 has a power line of a supply system to supply electric power from the power substation 94 and a power line of a regenerative system to supply the electric power output by the electric power supply system 100 to the surrounding equipment 97. With the above configuration, the electric power output by the power substation 94 is supplied to the station building equipment 96 and the surrounding equipment 97, and the electric power output by the electric power supply system 100 flows in a direction from the station building equipment 96 toward the power substation 94 and then is supplied to the surrounding equipment 97.

The electric power supply system 100 includes the station building auxiliary power source device 1 that converts the regenerated electric power supplied from the railway vehicle 93 via the railway power supply line 92 into electric power for supply to the station building equipment 96 and the surrounding equipment 97, a power meter 21 that measures an amount of electric power flowing between the power substation 94 and the station building equipment 96, and an output device 22 that acquires an external supply amount from the station building auxiliary power source device 1 to the surrounding equipment 97 that is obtained by the station building auxiliary power source device 1 and that displays the acquired external supply amount or transmits the external supply amount to an external device.

The station building auxiliary power source device 1 and the station building equipment 96 are each ground equipment under control of a railway operator, while the surrounding equipment 97 is equipment under control of another operator, that is, an operator different than the railway operator. By supplying electric power from the station building auxiliary power source device 1 to the surrounding equipment 97 under the control of the other operator, the railway operator receives compensation from the other operator based on the external supply amount. In other words, the railway operator can profit by selling surplus regenerated electric power to the other operator.

The station building auxiliary power source device 1 includes a power converter 11 that converts the regenerated electric power supplied from the railway vehicle 93 via the railway power supply line 92 into electric power for supply to the station building equipment 96 and the surrounding equipment 97, a power conversion controller 12 that controls multiple switching elements included in the power converter 11, and a supply amount determiner 13 that obtains the external supply amount that is an amount of electric power supplied from the station building auxiliary power source device 1 to the surrounding equipment 97.

The power converter 11 includes a Direct Current to Direct Current (DC/DC) conversion circuit 14 that converts the high-voltage DC power supplied from the railway vehicle 93 into low-voltage DC power, a Direct Current to Alternating Current (DC/AC) conversion circuit 15 that converts the low-voltage DC power output by the DC/DC conversion circuit 14 into AC power.

The power conversion controller 12 monitors a voltage of the railway power supply line 92 and controls the respective switching elements of the DC/DC conversion circuit 14 and the DC/AC conversion circuit 15 of the power converter 11 in accordance with the voltage of the railway power supply line 92. In detail, the power conversion controller 12 acquires a measurement value of a non-illustrated voltmeter that measures an input voltage applied to a terminal of the station building auxiliary power source device 1 that is connected to the railway power supply line 92, and uses the acquired measurement value as the voltage of the railway power supply line 92, that is, as an overhead line voltage.

In response to the overhead line voltage being higher than or equal to a starting voltage, for example, 1,600 V, the power conversion controller 12 controls the multiple switching elements of the power converter 11 to cause the power converter 11 to perform power conversion. The starting voltage is, for example, an upper limit of a target range for the voltage of the railway power supply line 92. The target range is defined by a minimum voltage necessary for supplying electric power to the railway vehicle 93, a voltage that the railway power supply line 92 can withstand, and the like.

The power conversion controller 12 holds, in advance, information on the upper limit of the target range.

The power conversion controller 12 adjusts a conduction ratio of the switching elements of the DC/DC conversion circuit 14 to maintain an output voltage of the DC/DC conversion circuit 14 in the target range. The station building auxiliary power source device 1 performs grid interconnection to the equipment power supply line 95 and thereby performs control for matching the voltage and frequency or the voltage and phase. The power conversion controller 12 determines a current command value from a value of current output by the DC/AC conversion circuit 15 and a target value of this current. The power conversion controller 12 generates, based on the current command value, gate signals for on-off switching of the respective switching elements of the DC/AC conversion circuit 15, and outputs the gate signals to the respective switching elements. By the power conversion controller 12 controlling the power converter 11 as described above, the regenerated electric power supplied from the railway vehicle 93 is converted into AC power for supply to the station building equipment 96 and the surrounding equipment 97.

Upon the power conversion controller 12 starting control of the power converter 11, the supply amount determiner 13 acquires, from the power meter 21 that measures the amount of electric power flowing between the power substation 94 and the station building equipment 96, a measurement value of the amount of electric power flowing between the power substation 94 and the station building equipment 96. When an output power of the power converter 11 is larger than a power consumption of the station building equipment 96, a part of the output power of the power converter 11 is supplied to the surrounding equipment 97 via the equipment power supply line 95 that connects the power substation 94 to the surrounding equipment 97. In this case, the supply amount determiner 13 obtains, from the amount of electric power flowing from the power converter 11 toward the power substation 94 that is measured by the power meter 21, the external supply amount that is an amount of electric power supplied to the surrounding equipment 97.

The output device 22 acquires the external supply amount from the supply amount determiner 13 and displays the acquired external supply amount or transmits the acquired external supply amount to the external device. The external supply amount corresponds to an amount of electricity sold from the electric power supply system 100 to the surrounding equipment 97. The output device 22 transmits the external supply amount to, for example, a power management device of the railway operator. This allows the railway operator to grasp the amount of sold electricity with regenerated electric power.

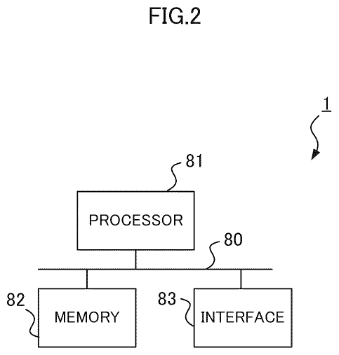

FIG. 2 illustrates a control section of the station building auxiliary power source device 1 having the aforementioned configuration, in other words, hardware configuration of the power conversion controller 12 and the supply amount determiner 13. The power conversion controller 12 and the supply amount determiner 13 each include a processor 81, a memory 82, and an interface 83. The processor 81, the memory 82, and the interface 83 are connected to each other via a bus 80. The functions of the components of the power conversion controller 12 and the supply amount determiner 13 are achieved by software, firmware, or a combination of software and firmware. The software and firmware are described in the form of programs, and stored in the memory 82. The processor 81 reads and executes the programs stored in the memory 82 to achieve the functions of the aforementioned components. That is, the memory 82 stores programs for executing processing of each component of the power conversion controller 12 or processing of each component of the supply amount determiner 13.

The memory 82 is, for example, a non-volatile or volatile semiconductor memory such as a random access memory (RAM), a read-only memory (ROM), a flash memory, an erasable programmable read-only memory (EPROM), or an electrically erasable and programmable read-only memory (EEPROM), or a magnetic disk, a flexible disk, an optical disk, a compact disc, a mini disc, or a digital versatile disc (DVD).

The power conversion controller 12 is connected to the power converter 11, specifically, to the DC/DC conversion circuit 14 and the DC/AC conversion circuit 15, via the interface 83. The supply amount determiner 13 is connected to the power meter 21 and the output device 22 via the interface 83. The interface 83 includes an interface module complying with one or more standards as appropriate for connection targets.

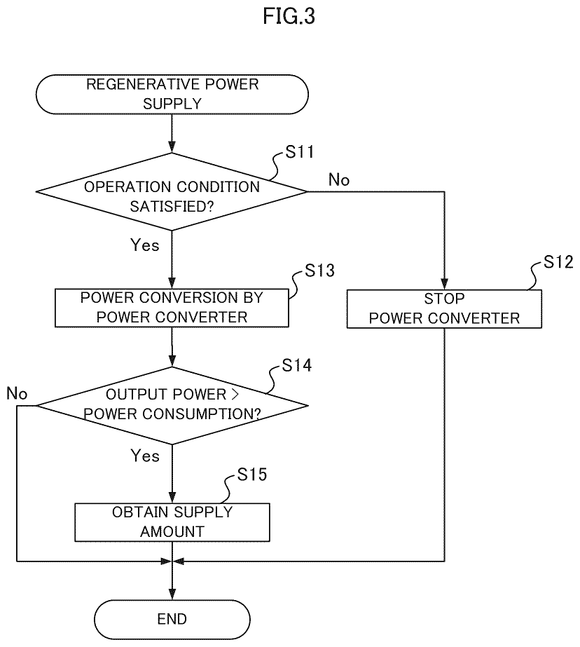

The regenerative power supply performed by the station building auxiliary power source device 1 having the aforementioned configuration is described using FIG. 3. Upon starting up, the station building auxiliary power source device 1 starts the processing in FIG. 3. The power converter 11 is taken to be stopped at the start of the processing in FIG. 3. The power conversion controller 12 determines whether an operation condition is satisfied (step S11).

In Embodiment 1, the power conversion controller 12 monitors the overhead line voltage based on the measurement value of the voltmeter and determines whether the overhead line voltage is higher than or equal to the upper limit of the target range, for example, 1,600 V. While the operation condition is not satisfied, specifically, the overhead line voltage has not reached the upper limit of the target range (No in step S11), the power conversion controller 12 stops the power converter 11 (step S12). The expression “stop the power converter 11” is taken to include keeping the power converter 11 stopped.

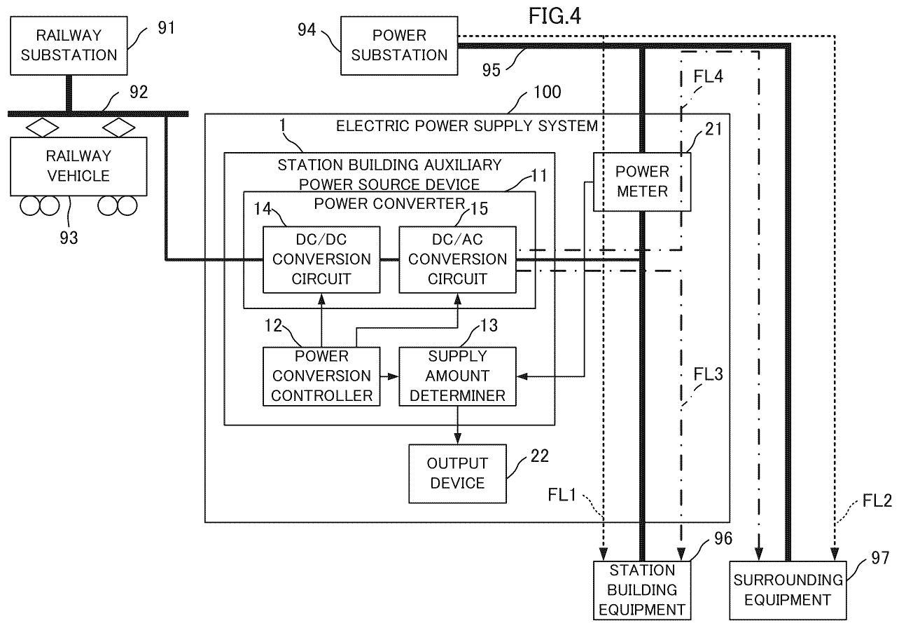

While the operation condition is not satisfied and thus the power converter 11 is stopped, electric power is not supplied from the power converter 11 to the station building equipment 96 and the surrounding equipment 97. In this situation, the station building equipment 96 and the surrounding equipment 97 receive supply of electric power from the power substation 94 as described by electric power flows FL1 and FL2 indicated by the dotted lines in FIG. 4, respectively.

As illustrated in FIG. 3, when the operation condition is satisfied, specifically, when the overhead line voltage reaches the upper limit of the target range (Yes in step S11), the power conversion controller 12 controls the power converter 11 and the power converter 11 performs power conversion (step S13). In step S13, the power conversion controller 12 controls the power converter 11 in accordance with the overhead line voltage.

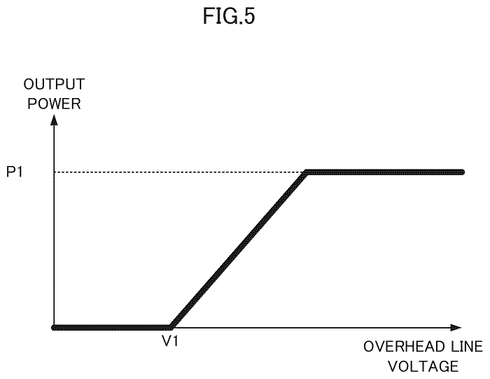

In detail, as illustrated in FIG. 5, when the overhead line voltage reaches an upper limit V1 of the target range, the power conversion controller 12 starts controlling the power converter 11. The power conversion controller 12 increases the output power of the power converter 11 in response to an increase in the overhead line voltage. When the output power of the power converter 11 reaches an upper power limit P1, the power conversion controller 12 performs control to maintain the output power of the power converter 11 at the upper power limit P1 even with further increase in the overhead line voltage.

Upon start of the power conversion by the power converter 11, electric power is supplied from the power converter 11 to the station building equipment 96, as described by the electric power flow FL3 that is indicated by the single-dotted line of FIG. 4. When the output power of the power converter 11 increases and the output power of the power converter 11 becomes larger than the power consumption of the station building equipment 96, electric power is supplied from the power converter 11 to the station building equipment 96 and the surrounding equipment 97 as described by the electric power flows FL3 and FL4 that are indicated by the single-dotted lines of FIG. 4, respectively.

As illustrated in FIG. 3, the supply amount determiner 13 determines, from the measurement value of the power meter 21, whether the output power of the power converter 11 is larger than the power consumption of the station building equipment 96 (step S14). In detail, the supply amount determiner 13 determines, from the measurement value of the power meter 21, whether the flow of electric power from the power converter 11 to the surrounding equipment 97 that is indicated by the electric power flow FL4 is occurring. When the flow of electric power from the power converter 11 to the surrounding equipment 97 is occurring, the output power of the power converter 11 can be deemed as larger than the power consumption of the station building equipment 96.

When the flow of electric power from the power converter 11 to the surrounding equipment 97 that is indicated by the electric power flow FL4 is occurring, in other words, when the output power of the power converter 11 is larger than the power consumption of the station building equipment 96 (Yes in step S14), the supply amount determiner 13 obtains, as the external supply amount, an amount of electric power from the power converter 11 to the surrounding equipment 97 that is indicated by the measurement value of the power meter 21 (step S15).

When the flow of electric power from the power converter 11 to the surrounding equipment 97 is not occurring, in other words, when the output power of the power converter 11 is equal to or smaller than the power consumption of the station building equipment 96 (No in step S14), the processing in step S15 is not executed.

When the flow of electric power from the power converter 11 to the surrounding equipment 97 that is indicated by the electric power flow FLA is not occurring (No in step S14) or when the processing in step S12 or step S15 is completed, the station building auxiliary power source device 1 ends processing of the regenerative power supply.

While being activated, the station building auxiliary power source device 1 repeats the aforementioned processing of the regenerative power supply at defined intervals. In step S15, the supply amount determiner 13 obtains the external supply amount in kWh based on the amount of electric power in kW indicated by the measurement value of the power meter 21 and the repetition intervals at which the aforementioned processing of the regenerative power supply is repeated. As an example, the supply amount determiner 13 obtains the external supply amount in kWh by assuming that the amount of electric power indicated by the measurement value of the power meter 21 was output over a period corresponding to the repetition intervals.

When the overhead line voltage decreases and the operation condition becomes unsatisfied after the station building auxiliary power source device 1 repeats the processing of the regenerative power supply illustrated in FIG. 3 and electric power is supplied from the power converter 11 to the station building equipment 96 and the surrounding equipment 97 (No in step S11), the power conversion controller 12 causes the power converter 11 to stop operation (step S12) and the station building auxiliary power source device 1 stops the processing of the regenerative power supply.

As described above, the station building auxiliary power source device 1 according to Embodiment 1 supplies electric power to the station building equipment 96 and the surrounding equipment 97 via the equipment power supply line 95 when the output power of the power converter 11 included in the station building auxiliary power source device 1 is larger than the power consumption of the station building equipment 96. This configuration enables consumption of regenerated electric power even in the case of occurrence of fluctuation in power consumption by the station building equipment 96.

As described above, the station building auxiliary power source device 1 supplies electric power to the surrounding equipment 97, obtains the external supply amount that is an amount of electric power supplied to the surrounding equipment 97, and transmits the obtained external supply amount to the output device 22. The railway operator managing the station building where the station building auxiliary power source device 1 is arranged can sell electricity from the station building auxiliary power source device 1 to the surrounding equipment 97 and can acquire, from the output device 22, the external supply amount, that is, data indicating the amount of sold electricity.

### Embodiment 2

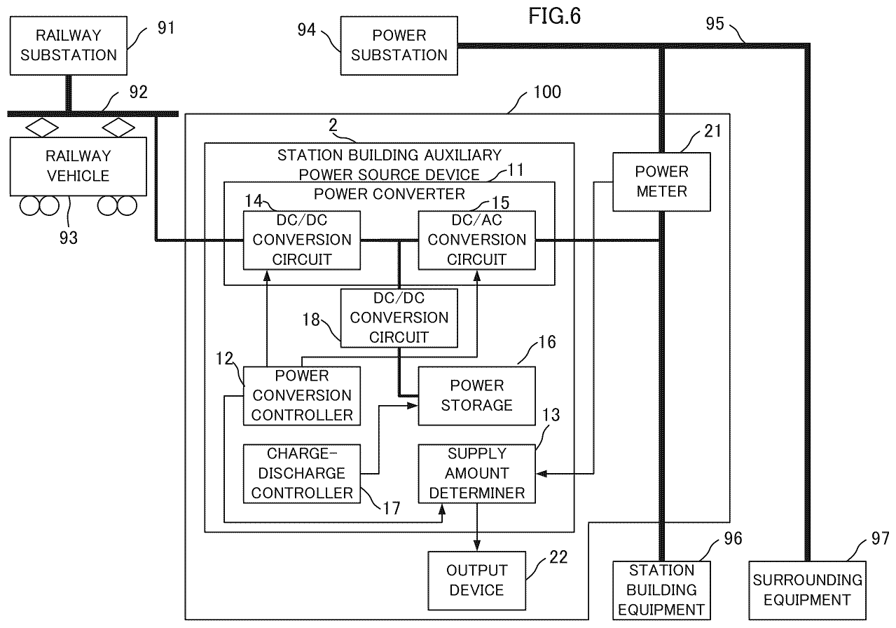

The configuration of the station building auxiliary power source device is not limited to the above example. In Embodiment 2, a station building auxiliary power source device that includes a power storage is described. A station building auxiliary power source device 2 illustrated in FIG. 6 includes, in addition to the components of the station building auxiliary power source device 1 according to Embodiment 1, a power storage 16 that is charged with electricity supplied from the power converter 11 and supplies electric power to the power converter 11, a charge-discharge controller 17 that performs switching between charge and discharge of the power storage 16, and a DC/DC conversion circuit 18 arranged between the power storage 16 and the power converter 11.

The power storage 16 is connected to the power converter 11, specifically, between output terminals of the DC/DC conversion circuit 14, via the DC/DC conversion circuit 18. During charging, the power storage 16 is charged with DC power output by the DC/DC conversion circuit 14. During discharging, the power storage 16 supplies DC power to the DC/AC conversion circuit 15.

The charge-discharge controller 17 controls a charge-discharge circuit included in the power storage 16 and performs switching between discharging from the power storage 16 and charging of the power storage 16 with the output power of the DC/DC conversion circuit 14.

The DC/DC conversion circuit 18 converts the DC power output by the DC/DC conversion circuit 14 into electric power to charge the power storage 16 and supplies the converted electric power to the power storage 16. The DC/DC conversion circuit 18 converts the DC power resulting from the discharge from the power storage 16 into electric power for supply to the DC/AC conversion circuit 15 and outputs the converted electric power to the DC/AC conversion circuit 15. The DC/DC conversion circuit 18 may include a contactor, specifically, a DC electromagnetic contactor.

Hardware configuration of a control section of the station building auxiliary power source device 2, specifically, hardware configuration of the power conversion controller 12, the supply amount determiner 13 and the charge-discharge controller 17, is similar to that of the station building auxiliary power source device 1 according to Embodiment 1.

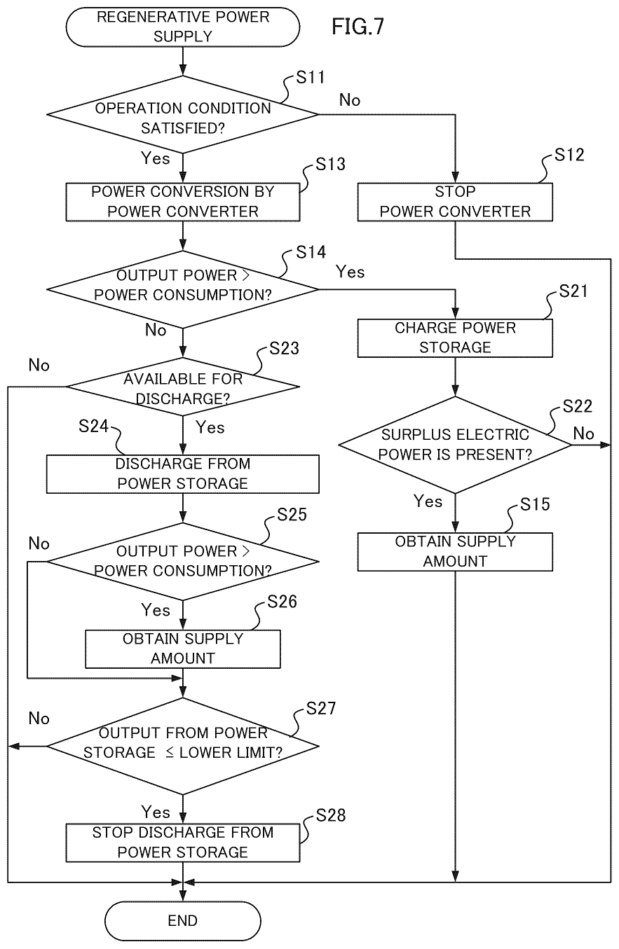

The regenerative power supply performed by the station building auxiliary power source device 2 having the aforementioned configuration is described using FIG. 7. The processing in steps S11 to S15 is similar to the processing of the regenerative power supply executed by the station building auxiliary power source device 1 according to Embodiment 1 that is illustrated in FIG. 3.

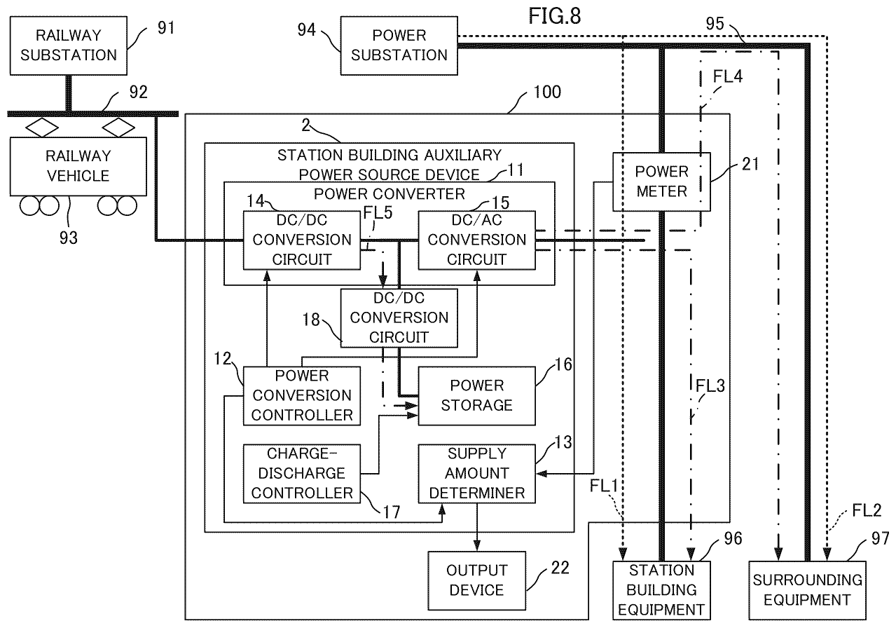

Similarly to Embodiment 1, while the operation condition is not satisfied and thus the power converter 11 is stopped, electric power is not supplied from the power converter 11 to the station building equipment 96 and the surrounding equipment 97. In this situation, the station building equipment 96 and the surrounding equipment 97 receive supply of electric power from the power substation 94 as described by electric power flows FL1 and FL2 indicated by the dotted lines in FIG. 8, respectively.

Upon start of the power conversion by the power converter 11, electric power is supplied from the power converter 11 to the station building equipment 96, as described by the electric power flow FL3 that is indicated by the single-dotted line of FIG. 8. When the output power of the power converter 11 increases and the output power of the power converter 11 becomes larger than the power consumption of the station building equipment 96, electric power is supplied from the power converter 11 to the station building equipment 96 and the surrounding equipment 97 as described by the electric power flows FL3 and FL4 that are indicated by the single-dotted lines of FIG. 8, respectively.

As illustrated in FIG. 7, when the flow of electric power from the power converter 11 to the surrounding equipment 97 that is indicated by the electric power flow FL4 is occurring, in other words, when the output power of the power converter 11 is larger than the power consumption of the station building equipment 96 (Yes in step S14), the charge-discharge controller 17 controls the charge-discharge circuit of the power storage 16 to charge the power storage 16 (step S21). As a result, as described by the electric power flow FL5 indicated by the single-dotted line of FIG. 8, electric power is supplied from the DC/DC conversion circuit 14 included in the power converter 11 to the power storage 16 via the DC/DC conversion circuit 18. This results in charging the power storage 16 with the DC power supplied from the DC/DC conversion circuit 14.

When surplus electric power is present with the output power of the power converter 11 being supplied to the station building equipment 96 and the power storage 16 being charged with the electric power supplied from the power converter 11, electric power is supplied from the power converter 11 to the station building equipment 96 and the surrounding equipment 97, as described by the electric power flows FL3 and FLA, respectively. In other words, when the output power of the power converter 11 is larger than a total of the power consumption of the station building equipment 96 and charging power of the power storage 16, electric power is supplied from the power converter 11 to the station building equipment 96 and the surrounding equipment 97, respectively, with the power storage 16 being charged with the electric power supplied from the power converter 11.

As illustrated in FIG. 7, the supply amount determiner 13 determines presence or absence of surplus electric power from the measurement value of the power meter 21 (step S22). When a flow of electric power from the power converter 11 to the surrounding equipment 97 is occurring with the power storage 16 being charged, then surplus electric power can be deemed as present.

When the flow of electric power from the power converter 11 to the surrounding equipment 97 that is indicated by the electric power flow FLA is occurring with the power storage 16 being charged, in other words, when surplus electric power is present (Yes in step S22), the supply amount determiner 13 obtains, as the external supply amount, an amount of electric power that is supplied from the power converter 11 to the surrounding equipment 97 and that is indicated by the measurement value of the power meter 21 (step S15).

When the flow of electric power from the power converter 11 to the surrounding equipment 97 is not occurring with the power storage 16 being charged, in other words, when surplus electric power is not present (No in step S22), the processing in step S15 is not executed.

When the flow of electric power from the power converter 11 to the surrounding equipment 97 that is indicated by the electric power flow FLA is not occurring (No in step S14), the charge-discharge controller 17 determines whether the power storage 16 is available for discharge (step S23). Specifically, the charge-discharge controller 17 determines that the power storage 16 is available for discharge when the state of charge of the power storage 16 is sufficient to supply electric power to the DC/AC conversion circuit 15, for example, 20% or more. When the power storage 16 is not available for discharge (No in step S23), the processing in subsequent steps S24-S28 is not executed.

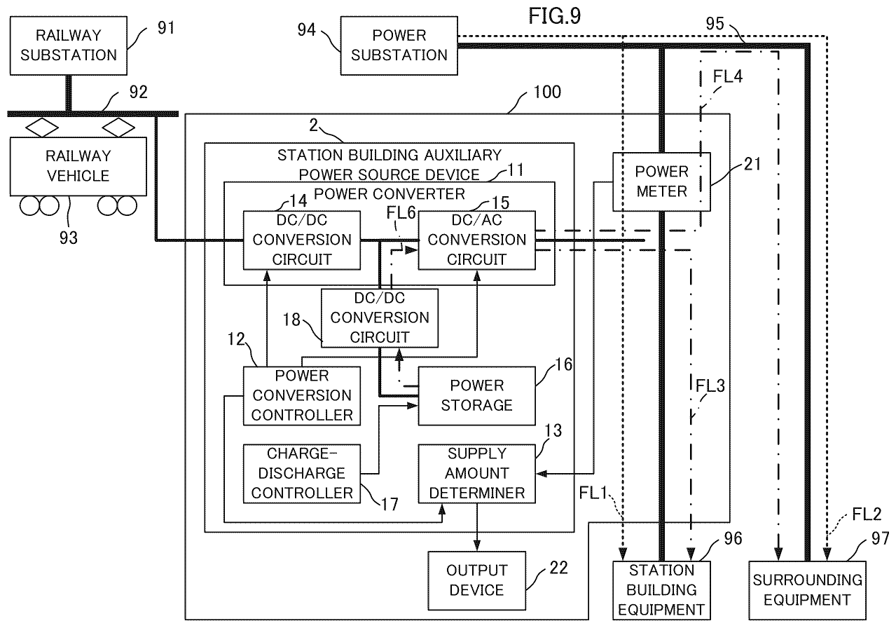

When the power storage 16 is available for discharge (Yes in step S23), the charge-discharge controller 17 controls the charge-discharge circuit of the power storage 16 to cause the power storage 16 to discharge (step S24). As a result, as described by the electric power flow FL6 indicated by the single-dotted line of FIG. 9, electric power is supplied from the power storage 16 to the DC/AC conversion circuit 15 included in the power converter 11 via the DC/DC conversion circuit 18. The DC/AC conversion circuit 15 converts the DC power supplied from the DC/DC conversion circuit 14 and the power storage 16 into AC power and outputs the converted AC power.

When the output power of the power converter 11 is larger than the power consumption of the station building equipment 96 with the power storage 16 discharging, electric power is supplied from the power converter 11 to the station building equipment 96 and the surrounding equipment 97 as described by the electric power flows FL3 and FL4 that are indicated by the single-dotted lines of FIG. 9, respectively.

As illustrated in FIG. 7, when the flow of electric power from the power converter 11 to the surrounding equipment 97 that is indicated by the electric power flow FL4 is occurring with the power storage 16 discharging, in other words, when the output power of the power converter 11 is larger than the power consumption of the station building equipment 96 (Yes in step S25), the supply amount determiner 13 obtains, as the external supply amount, an amount of electric power that is supplied from the power converter 11 to the surrounding equipment 97 and that is indicated by the measurement value of the power meter 21 (step S26).

When the flow of electric power from the power converter 11 to the surrounding equipment 97 is not occurring with the power storage 16 discharging, in other words, when the output power of the power converter 11 is equal to or smaller than the power consumption of the station building equipment 96 (No in step S25), the processing in step S26 is not executed.

The charge-discharge controller 17 determines whether output from the power storage 16 is equal to or lower than a lower limit (step S27). The lower limit is determined based on output of the power storage 16 at which a remaining amount of the power storage 16 can be deemed as an amount at which electric power can be supplied to the DC/AC conversion circuit 15.

When the output of the power storage 16 is equal to or lower than the lower limit (Yes in step S27), the charge-discharge controller 17 stops the discharge from the power storage 16 (step S28).

When the output of the power storage 16 is higher than the lower limit (No in step S27), the processing in step S28 is not executed.

After completion of the processing in step S12, step S15 or step S28, when surplus electric power is not present (No in step S22), when the power storage 16 is not available for discharge (No in step S23), or when the output of the power storage 16 is higher than the lower limit (No in step S27), the station building auxiliary power source device 2 ends the processing of the regenerative power supply. While being activated, the station building auxiliary power source device 2 repeats the aforementioned processing at defined intervals. In steps S15 and S26, the supply amount determiner 13 obtains the external supply amount in kWh based on the amount of electric power in kW indicated by the measurement value of the power meter 21 and the repetition intervals at which the aforementioned processing is repeated.

As described above, the station building auxiliary power source device 2 according to Embodiment 2 includes the power storage 16, and when the output power of the power converter 11 is larger than the power consumption of the station building equipment 96, charges the power storage 16 with the electric power supplied from the power converter 11. When the output power of the power converter 11 is equal to or smaller than the power consumption of the station building equipment 96, electric power is supplied from the power converter 11 to the station building equipment 96 with the regenerated electric power supplied from the railway vehicle 93 and the electric power resulted from the discharge from the power storage 16. This configuration enables consumption of regenerated electric power even in the case of occurrence of fluctuation in power consumption by the station building equipment 96. Furthermore, even when regenerated electric power is low, the electricity charged in the power storage 16 enables supplying electric power to the station building equipment 96.

### Embodiment 3

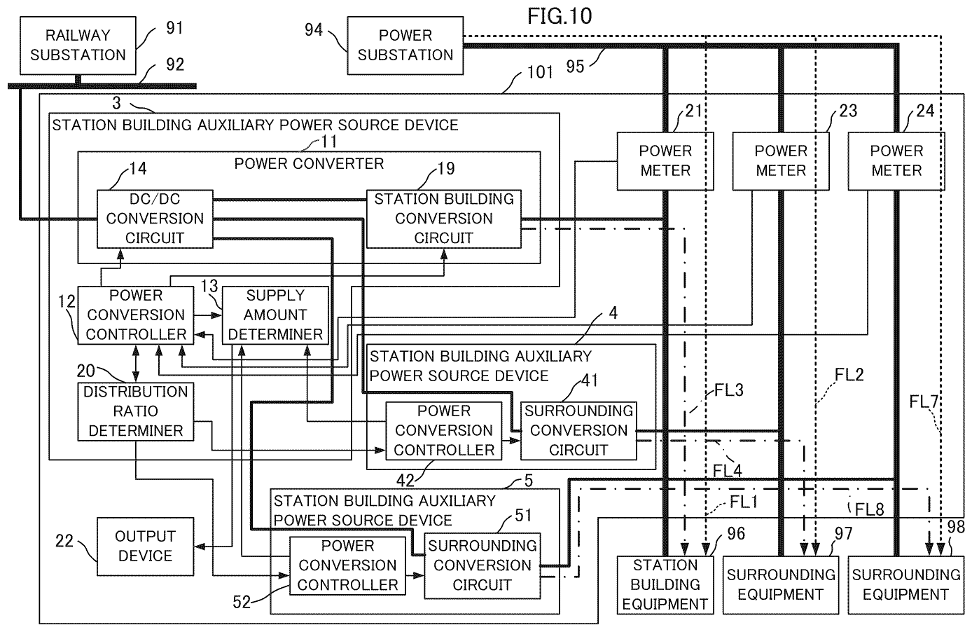

The electric power supply system is not limited to the aforementioned examples. In Embodiment 3, an electric power supply system that includes multiple station building auxiliary power source devices is described. An electric power supply system 101 illustrated in FIG. 10 includes station building auxiliary power source devices 3, 4 and 5 that convert regenerated electric power into electric power for supply to the station building equipment 96, the surrounding equipment 97, and surrounding equipment 98, respectively. The electric power supply system 101 preferably further includes a power meter 21 that measures an amount of electric power flowing between the power substation 94 and the station building equipment 96, a power meter 23 that measures an amount of electric power flowing between the power substation 94 and the surrounding equipment 97, and a power meter 24 that measures an amount of electric power flowing between the power substation 94 and the surrounding equipment 98. For simplicity, the railway vehicle 93 is not illustrated in FIG. 10.

The station building auxiliary power source device 3 is connected to the railway power supply line 92 and to the equipment power supply line 95 that connects the power substation 94 to the station building equipment 96. The power converter 11 included in the station building auxiliary power source device 3 includes the DC/DC conversion circuit 14 that converts the regenerated electric power supplied via the railway power supply line 92 into low-voltage DC power, and a station building conversion circuit 19 that converts the low-voltage DC power supplied from the DC/DC conversion circuit 14 into AC power for supply to the station building equipment 96.

The station building auxiliary power source device 3 further includes a distribution ratio determiner 20 that determines a distribution ratio based on the power consumptions of the station building equipment 96, the surrounding equipment 97, and the surrounding equipment 98.

The power conversion controller 12 acquires the distribution ratio from the distribution ratio determiner 20 and acquires measurement values from the power meters 21, 23 and 24. The power conversion controller 12 controls the power converter 11 in accordance with the distribution ratio and the measurement values of the power meters 21, 23 and 24.

The supply amount determiner 13 acquires output power values from the station building auxiliary power source devices 4 and 5. The supply amount determiner 13 obtains, from the acquired output power values, for each of the surrounding equipment 97 and the surrounding equipment 98, an individual supply amount indicating an amount of electric power supplied to the surrounding equipment.

The station building conversion circuit 19 has configuration similar to that of the DC/AC conversion circuit 15 of Embodiment 1. The station building conversion circuit 19 converts the low-voltage DC power supplied from the DC/DC conversion circuit 14 into AC power, and supplies the converted AC power to the station building equipment 96 via the equipment power supply line 95.

The distribution ratio determiner 20 determines the distribution ratio based on the power consumptions of the station building equipment 96, the surrounding equipment 97, and the surrounding equipment 98, and sends an upper power limit in accordance with the determined distribution ratio to each of the power conversion controllers 12, 42 and 52. For example, the distribution ratio determiner 20 determines the distribution ratio based on expected values, historical averages, target values, and the like of the power consumptions of the station building equipment 96, the surrounding equipment 97, and the surrounding equipment 98. Upon the power conversion controller 12 starting control of the power converter 11, the distribution ratio determiner 20 sends an operation start instruction to the power conversion controllers 42 and 52.

The station building auxiliary power source device 4 includes a surrounding conversion circuit 41 that converts the low-voltage DC power supplied from the DC/DC conversion circuit 14 of the power converter 11 included in the station building auxiliary power source device 3 into AC power, and a power conversion controller 42 that controls the surrounding conversion circuit 41.

The surrounding conversion circuit 41 has configuration similar to that of the station building conversion circuit 19, that is, similar to that of the DC/AC conversion circuit 15 of Embodiment 1.

The power conversion controller 42 determines a current command value from a value of current output by the surrounding conversion circuit 41 and a target value of this current. The power conversion controller 42 generates, based on the current command value, gate signals for on-off switching of the respective switching elements of the surrounding conversion circuit 41, and outputs the gate signals to the respective switching elements. The power conversion controller 42 determines the output power value of the surrounding conversion circuit 41 from a value of a phase voltage output by the surrounding conversion circuit 41 and a value of a phase current output by the surrounding conversion circuit 41. The power conversion controller 42 sends the determined output power value to the supply amount determiner 13.

The station building auxiliary power source device 5 includes a surrounding conversion circuit 51 that converts the low-voltage DC power supplied from the DC/DC conversion circuit 14 of the power converter 11 included in the station building auxiliary power source device 3 into AC power, and a power conversion controller 52 that controls the surrounding conversion circuit 51.

The surrounding conversion circuit 51 has configuration similar to that of the station building conversion circuit 19, that is, similar to that of the DC/AC conversion circuit 15 of Embodiment 1.

The power conversion controller 52 determines a current command value from a value of current output by the surrounding conversion circuit 51 and a target value of this current. The power conversion controller 52 generates, based on the current command value, gate signals for on-off switching of the respective switching elements of the surrounding conversion circuit 51, and outputs the gate signals to the respective switching elements. The power conversion controller 52 determines the output power value of the surrounding conversion circuit 51 from a value of a phase voltage output by the surrounding conversion circuit 51 and a value of a phase current output by the surrounding conversion circuit 51. The power conversion controller 52 sends the determined output power value to the supply amount determiner 13.

The power meter 21 has configuration similar to that of the power meter 21 of Embodiment 1. The power meter 21 sends the measurement value to the power conversion controller 12. The power meters 23 and 24 have configuration similar to that of the power meter 21. The power meter 23 measures the amount of electric power flowing between the power substation 94 and the surrounding equipment 97 and sends the measurement value to the power conversion controller 12. The power meter 24 measures the amount of electric power flowing between the power substation 94 and the surrounding equipment 98 and sends the measurement value to the power conversion controller 12.

Hardware configuration of a control section of the station building auxiliary power source devices 3, 4 and 5 is similar to that of the station building auxiliary power source device 1 according to Embodiment 1. The station building auxiliary power source device 3 is connected to the station building auxiliary power source devices 4 and 5 via the interface 83. The station building auxiliary power source devices 4 and 5 are each connected to the station building auxiliary power source device 3 via the interface 83.

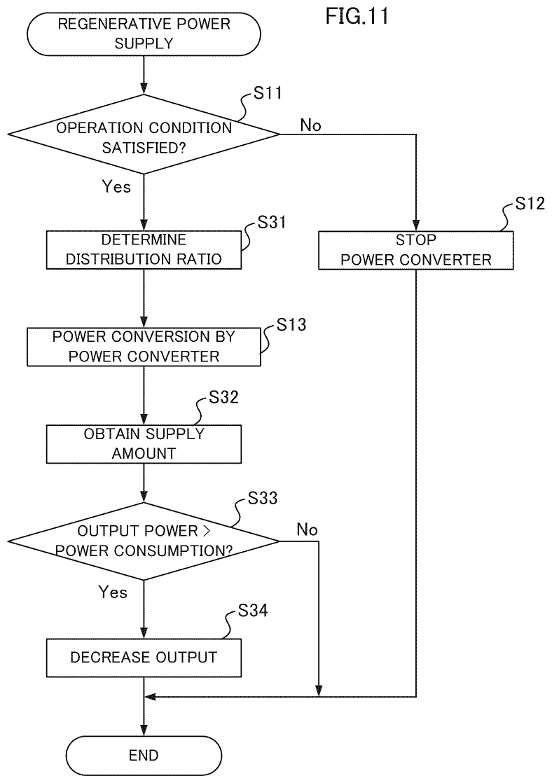

The regenerative power supply performed by the electric power supply system 101 having the aforementioned configuration is described using FIG. 11. Upon the station building auxiliary power source devices 3-5 starting up, the electric power supply system 101 starts the processing in FIG. 11. The power converter 11 included in the station building auxiliary power source device 3 is taken to be stopped at the start of the processing in FIG. 11. The processing in steps S11 and S12 is similar to the processing of the regenerative power supply executed by the station building auxiliary power source device 1 according to Embodiment 1 that is illustrated in FIG. 3.

Similarly to Embodiment 1, while the operation condition is not satisfied and thus the power converter 11 is stopped, electric power is not supplied from the power converter 11 included in the station building auxiliary power source device 3 to the station building equipment 96 and electric power is not supplied from the station building auxiliary power source devices 4 and 5 to the surrounding equipment 97 and the surrounding equipment 98. In this situation, the station building equipment 96, the surrounding equipment 97, and the surrounding equipment 98 receive supply of electric power from the power substation 94 as described by electric power flows FL1, FL2 and FL7 indicated by the dotted lines in FIG. 10, respectively.

When the operation condition is satisfied, specifically, when the overhead line voltage reaches the upper limit of the target range (Yes in step S11), the distribution ratio determiner 20 determines the distribution ratio (step S31). The distribution ratio determiner 20 sends, to each of the power conversion controllers 12, 42 and 52, notification of the upper power limit in accordance with the determined distribution ratio.

The power conversion controller 12 controls the power converter 11 in accordance with the distribution ratio, causing the power converter 11 to perform power conversion (step S13). In detail, similarly to Embodiment 1, the power conversion controller 12 controls the DC/DC conversion circuit 14. The power conversion controller 12 controls the station building conversion circuit 19 in accordance with the distribution ratio. The station building conversion circuit 19 supplies, to the station building equipment 96, electric power that is equal to or lower than the upper power limit in accordance with the distribution ratio. Upon the power conversion controller 12 starting control of the power converter 11, the distribution ratio determiner 20 sends an operation start instruction to the power conversion controllers 42 and 52 included in the station building auxiliary power source devices 4 and 5.

Upon start of the power conversion by the power converter 11, electric power is supplied from the power converter 11 to the station building equipment 96, as described by the electric power flow FL3 that is indicated by the single-dotted line of FIG. 10. Upon start of the power conversion by the surrounding conversion circuit 41 included in the station building auxiliary power source device 4, electric power is supplied from the station building auxiliary power source device 4 to the surrounding equipment 97, as described by electric power flow FL4 that is indicated by the single-dotted line. Upon start of the power conversion by the surrounding conversion circuit 51 included in the station building auxiliary power source device 5, electric power is supplied from the station building auxiliary power source device 5 to the surrounding equipment 98, as described by electric power flow FL8 that is indicated by the single-dotted line.

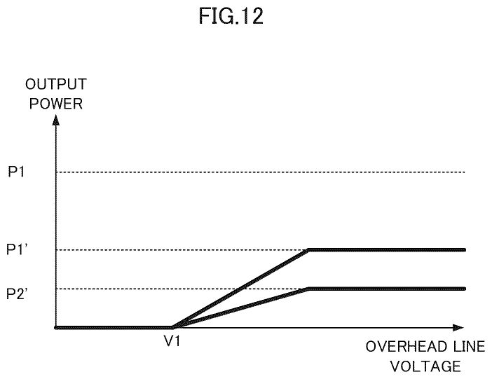

The upper power limit in accordance with the distribution ratio is smaller than the upper power limit P1 of the output power of the station building auxiliary power source device 1 according to Embodiment 1. As an example, as illustrated in FIG. 12, controlling the power converter 11 by the power conversion controller 12 included in the station building auxiliary power source device 3 causes a gradual increase in the output power of the power converter 11, leading to an increase to reach an upper power limit P1′ that is smaller than the upper power limit P1 of the output power of the station building auxiliary power source device 1 according to Embodiment 1.

Upon acquiring the operation start instruction, the power conversion controllers 42 and 52 included in the station building auxiliary power source devices 4 and 5 start control of the surrounding conversion circuits 41 and 51. Controlling the surrounding conversion circuits 41 and 51 by the power conversion controllers 42 and 52 causes a gradual increase in the output power of the surrounding conversion circuits 41 and 51, leading to an increase to reach an upper power limit P2′ that is smaller than the upper power limit P1 of the output power of the station building auxiliary power source device 1 according to Embodiment 1.

As illustrated in FIG. 11, the supply amount determiner 13 obtains, from the output power values acquired from the power conversion controllers 42 and 52, for each of the surrounding equipment 97 and the surrounding equipment 98, the individual supply amount indicating an amount of electric power supplied to the surrounding equipment (step S32).

The power conversion controller 12 determines, from the measurement values of the power meters 21, 23 and 24, whether the output power of each of the station building auxiliary power source devices 3, 4 and 5 is larger than the power consumption of the corresponding equipment of the station building equipment 96, the surrounding equipment 97, and the surrounding equipment 98 (step S33).

In detail, the power conversion controller 12 determines, from the measurement value of the power meter 21, whether a flow of electric power from the power converter 11 included in the station building auxiliary power source device 3 toward the power substation 94 is occurring. When the flow of electric power from the power converter 11 toward the power substation 94 is occurring, the output power of the station building auxiliary power source device 3 can be deemed as larger than the power consumption of the station building equipment 96.

Similarly, the power conversion controller 12 determines, from the measurement value of the power meter 23, whether a flow of electric power from the surrounding conversion circuit 41 included in the station building auxiliary power source device 4 toward the power substation 94 is occurring. When the flow of electric power from the surrounding conversion circuit 41 toward the power substation 94 is occurring, the output power of the station building auxiliary power source device 4 can be deemed as larger than the power consumption of the surrounding equipment 97.

Similarly, the power conversion controller 12 determines, from the measurement value of the power meter 24, whether a flow of electric power from the surrounding conversion circuit 51 included in the station building auxiliary power source device 5 toward the power substation 94 is occurring. When the flow of electric power from the surrounding conversion circuit 51 toward the power substation 94 is occurring, the output power of the station building auxiliary power source device 5 can be deemed as larger than the power consumption of the surrounding equipment 98.

When the output power of the station building auxiliary power source device 3 is larger than the power consumption of the station building equipment 96, the output power of the station building auxiliary power source device 4 is larger than the power consumption of the surrounding equipment 97, or the output power of the station building auxiliary power source device 5 is larger than the power consumption of the surrounding equipment 98 (Yes in step S33), the power conversion controller 12 decreases output of any of the station building auxiliary power source devices 3, 4 and 5 (step S34).

As an example, when the output power of the station building auxiliary power source device 3 is larger than the power consumption of the station building equipment 96 while the output powers of the station building auxiliary power source devices 4 and 5 are smaller than the power consumptions of the surrounding equipment 97 and the surrounding equipment 98, the power conversion controller 12 adjusts the distribution ratio to decrease the electric power supplied to the station building conversion circuit 19 and increase the electric power supplied to the surrounding conversion circuits 41 and 51. This decreases the output of the station building auxiliary power source device 3 and thereby suppresses supply of electric power from the station building auxiliary power source device 3 toward the power substation 94.

After completion of the processing in step S12 or step S34, or when the output power of each of the station building auxiliary power source devices 3, 4 and 5 is equal to or smaller than the power consumption of the corresponding equipment of the station building equipment 96, the surrounding equipment 97, and the surrounding equipment 98 (No in step S33), the electric power supply system 101 ends the processing of the regenerative power supply. While the station building auxiliary power source devices 3-5 are activated, the electric power supply system 101 repeats the aforementioned processing at defined intervals. In step S32, the supply amount determiner 13 obtains the individual supply amount in kWh based on the amount of electric power in kW indicated by the acquired output power values and the repetition intervals at which the aforementioned processing is repeated.

As described above, the electric power supply system 101 according to Embodiment 3 includes the station building auxiliary power source devices 3, 4 and 5 and can supply electric power with the regenerated electric power from the station building auxiliary power source devices 3, 4 and 5 to the station building equipment 96, the surrounding equipment 97, and the surrounding equipment 98, respectively. Due to this configuration, even in the case where the power consumption of the station building equipment 96 is small, the regenerated electric power can be consumed by the surrounding equipment 97 and the surrounding equipment 98.

The embodiments described above are not to be construed as limiting the scope of the present disclosure. The embodiments described above may be freely combined. As an example, the station building auxiliary power source devices 3-5 may include the power storage 16 and the charge-discharge controller 17.

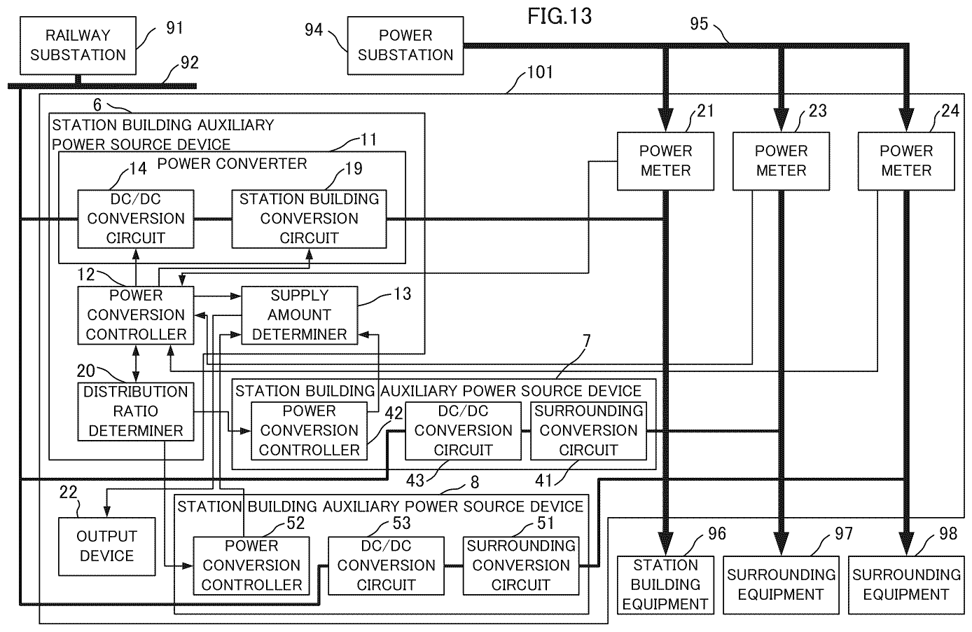

The configuration of the electric power supply systems 100 and 101 is not limited to the aforementioned examples and may be any configuration that enables supplying the regenerated electric power to the station building equipment 96, the surrounding equipment 97, and the surrounding equipment 98. For example, the method for distribution to the multiple station building auxiliary power source devices in the electric power supply system 101 is not limited to the aforementioned example. The electric power supply system 101 illustrated in FIG. 13 includes station building auxiliary power source devices 6, 7 and 8 that are each connected to the railway power supply line 92. For simplicity, the railway vehicle 93 is not illustrated in FIG. 13.

The station building auxiliary power source device 6 have configuration similar to that of the station building auxiliary power source device 3. The power converter 11 included in the station building auxiliary power source device 6 includes the DC/DC conversion circuit 14 and the station building conversion circuit 19.

The station building auxiliary power source device 7 includes, in addition to the components of the station building auxiliary power source device 4, a DC/DC conversion circuit 43 connected to the railway power supply line 92. The DC/DC conversion circuit 43 is controlled by the power conversion controller 42 and converts the regenerated electric power supplied from the railway vehicle 93 via the railway power supply line 92 into low-voltage DC power. The DC/DC conversion circuit 43 supplies the low-voltage DC power to the surrounding conversion circuit 41. For simplicity, arrows from the power conversion controller 42 toward the surrounding conversion circuit 41 and the DC/DC conversion circuit 43 are not illustrated in FIG. 13.

The station building auxiliary power source device 8 includes, in addition to the components of the station building auxiliary power source device 5, a DC/DC conversion circuit 53 connected to the railway power supply line 92. The DC/DC conversion circuit 53 is controlled by the power conversion controller 52 and converts the regenerated electric power supplied from the railway vehicle 93 via the railway power supply line 92 into low-voltage DC power. The DC/DC conversion circuit 53 supplies the low-voltage DC power to the surrounding conversion circuit 51. For simplicity, arrows from the power conversion controller 52 toward the surrounding conversion circuit 51 and the DC/DC conversion circuit 53 are not illustrated in FIG. 13.

The power conversion controller 12 controls the DC/DC conversion circuit 14 and the station building conversion circuit 19 based on the upper power limit in accordance with the distribution ratio acquired from the distribution ratio determiner 20. The power conversion controller 42 controls the DC/DC conversion circuit 43 and the surrounding conversion circuit 41 based on the upper power limit in accordance with the distribution ratio acquired from the distribution ratio determiner 20. The power conversion controller 52 controls the DC/DC conversion circuit 53 and the surrounding conversion circuit 51 based on the upper power limit in accordance with the distribution ratio acquired from the distribution ratio determiner 20.

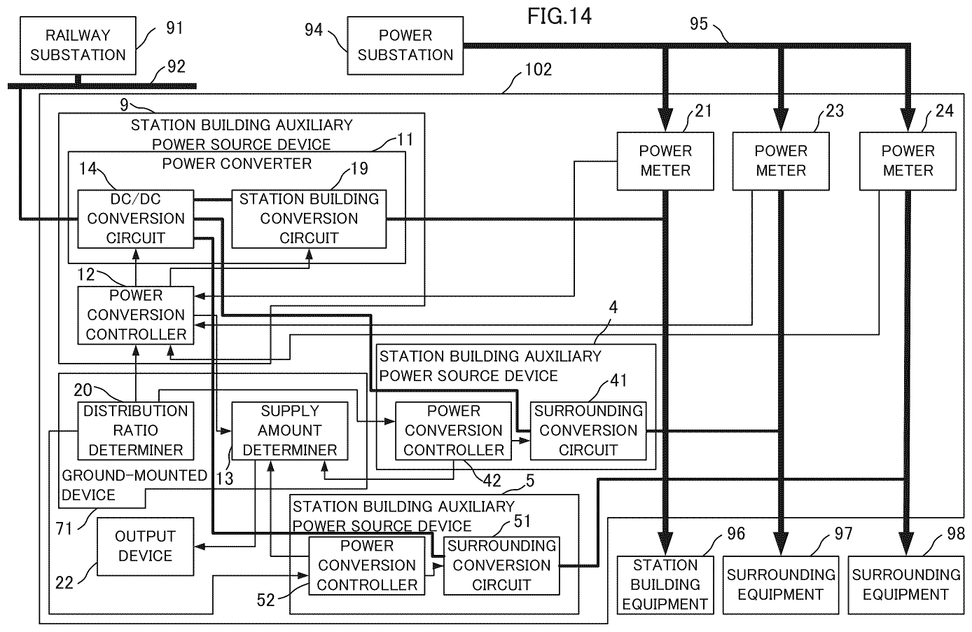

As another example, as illustrated in FIG. 14, an electric power supply system 102 may include a station building auxiliary power source device 9 that includes a part of the components of the station building auxiliary power source device 3 and a ground-mounted device 71 that includes the supply amount determiner 13 and the distribution ratio determiner 20. The supply amount determiner 13 and the distribution ratio determiner 20 that are included in the ground-mounted device 71 are similar to the supply amount determiner 13 and the distribution ratio determiner 20 that are included in the station building auxiliary power source device 3. The power conversion controller 12, the DC/DC conversion circuit 14, and the station building conversion circuit 19 that are included in the station building auxiliary power source device 9 are similar to the power conversion controller 12, the DC/DC conversion circuit 14, and the station building conversion circuit 19 that are included in the station building auxiliary power source device 3. The ground-mounted device 71 is a device separated from the station building auxiliary power source device 9.

As another example, the station building auxiliary power source devices 3, 4 and 5 may be achieved by one station building auxiliary power source device 3. In the case of this configuration, the station building auxiliary power source device 3 further includes the surrounding conversion circuits 41 and 51 and the power conversion controllers 42 and 52.

The operation condition for operation of the processing of the regenerative power supply is not limited to the aforementioned example. As an example, the power conversion controller 12 may determine whether the overhead line voltage is on an upward trend, and upon determining that the overhead line voltage is on an upward trend, control the power converter 11 to start power conversion by the power converter 11. In the case of this configuration, the power conversion controller 12 controls the power converter 11 until the overhead line voltage reaches the lower limit of the target range.

The supply amount determiner 13 included in the station building auxiliary power source devices 1 and 2 may acquire the power consumption of the station building equipment 96 from the station building equipment 96 and obtain the external supply amount from the measurement value of the power meter 21 and the power consumption of the station building equipment 96. In detail, the supply amount determiner 13 may use, as the external supply amount, a value obtained by subtracting, from the output power of the power converter 11, a result of subtraction of the amount of electric power flowing from the power substation 94 to the station building equipment 96 from the power consumption of the station building equipment 96.

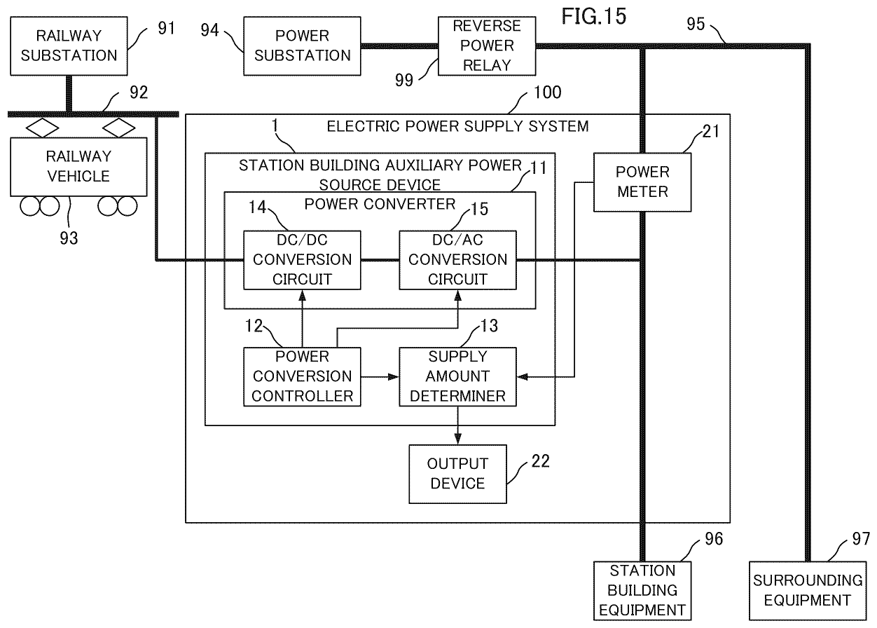

As illustrated in FIG. 15, the electric power supply system 100 may be connected to the power substation 94 via a reverse power relay 99 for suppressing the flow of electric power to the power substation 94.

The number of the surrounding equipment may be freely selected. As an example, the station building auxiliary power source device 1 may supply electric power via the equipment power supply line 95 to multiple targets that are each the surrounding equipment.

The electric power supply systems 100, 101 and 102 may receive supply of regenerated electric power from a railway vehicle 93 of an alternating-current feeding system. In the case of this configuration, the station building auxiliary power source devices 1-9 include a transformer that steps down high-voltage AC power and AC/DC conversion circuit that converts the stepped-down AC power into DC power.

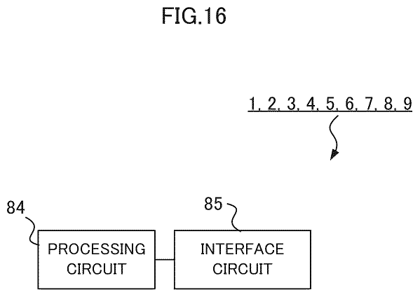

The hardware configuration of the station building auxiliary power source devices 1-9 is not limited to the aforementioned examples. FIG. 16 illustrates a modified example of the hardware configuration of the station building auxiliary power source devices 1-9. As illustrated in FIG. 16, the control section of the station building auxiliary power source devices 1-9 may be achieved by a processing circuit 84. As an example, the power conversion controller 12 included in the station building auxiliary power source device 1 is connected to the power converter 11, specifically, to the DC/DC conversion circuit 14 and the DC/AC conversion circuit 15, via an interface circuit 85. The supply amount determiner 13 included in the station building auxiliary power source device 1 is connected to the power meter 21 and the output device 22 via the interface circuit 85.

In the case where the processing circuit 84 is dedicated hardware, the processing circuit 84 is a single circuit, a combined circuit, a processor, an application specific integrated circuit (ASIC), a field programmable gate array (FPGA), or a combination thereof, for example. Each component of the station building auxiliary power source devices 1-9 may be achieved by an individual processing circuit 84 or a shared processing circuit 84.

A part of each function of the control section of the station building auxiliary power source devices 1-9 may be achieved by dedicated hardware and another part thereof may be achieved by software or firmware. For example, in the station building auxiliary power source device 1 according to Embodiment 1, the power conversion controller 12 may be achieved by the processing circuit 84 illustrated in FIG. 16 and the supply amount determiner 13 may be achieved by the processor 81 illustrated in FIG. 2 reading and executing the programs stored in the memory 82.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive sense. This detailed description, therefore, is not to be taken in a limiting sense, and the scope of the invention is defined only by the included claims, along with the full range of equivalents to which such claims are entitled.

### REFERENCE SIGNS LIST

1, 2, 3, 4, 5, 6, 7, 8, 9 Station building auxiliary power source device 11 Power converter
12, 42, 52 Power conversion controller
13 Supply amount determiner
14, 18, 43, 53 DC/DC conversion circuit
15 DC/AC conversion circuit
16 Power storage
17 Charge-discharge controller
19 Station building conversion circuit
20 Distribution ratio determiner
21, 23, 24 Power meter
22 Output device
41,51 Surrounding conversion circuit
71 Ground-mounted device
80 Bus
81 Processor
82 Memory
83 Interface
84 Processing circuit
85 Interface circuit
91 Railway substation
92 Railway power supply line
93 Railway vehicle
94 Power substation
95 Equipment power supply line
96 Station building equipment
97,98 Surrounding equipment
99 Reverse power relay
100, 101,102 Electric power supply system

1. A station building auxiliary power source device to be connected to a railway power supply line connecting, to an electric railway vehicle, a railway substation to supply electric power to the electric railway vehicle and an equipment power supply line connecting a power substation to station building equipment and surrounding equipment, the station building equipment being arranged in a station building and being to consume electric power, the surrounding equipment being arranged outside the station building and being to consume electric power, the power substation being to supply electric power to the station building equipment and the surrounding equipment, the station building auxiliary power source device comprising:
a power converter to convert regenerated electric power supplied from the electric railway vehicle via the railway power supply line into electric power for supply to the station building equipment and the surrounding equipment, and output the converted electric power; and
power conversion controlling circuitry to monitor a voltage of the railway power supply line and control the power converter in accordance with the voltage of the railway power supply line, wherein
when an output power of the power converter is larger than a power consumption of the station building equipment, the output power of the power converter is supplied to the station building equipment and the surrounding equipment via the equipment power supply line, and when the output power of the power converter is equal to or smaller than the power consumption of the station building equipment, the output power of the power converter is supplied to the station building equipment via the equipment power supply line.

2. The station building auxiliary power source device according to claim 1, further comprising:
a power storage connected to the power converter, wherein
when the output power of the power converter is larger than the power consumption of the station building equipment, the output power of the power converter is supplied to the station building equipment via the equipment power supply line and the power storage is charged with electric power supplied from the power converter.

3. The station building auxiliary power source device according to claim 2, wherein
when the output power of the power converter is larger than a total of the power consumption of the station building equipment and charging power of the power storage, the output power of the power converter is supplied to the station building equipment and the surrounding equipment via the equipment power supply line and the power storage is charged with the electric power supplied from the power converter.

4. The station building auxiliary power source device according to claim 2, wherein
when the output power of the power converter is equal to or smaller than the power consumption of the station building equipment, the power converter converts electric power supplied from the power storage into electric power for supply to the station building equipment and the surrounding equipment and outputs the converted electric power.

5. The station building auxiliary power source device according to claim 1, wherein
when the power converter is stopped, upon the voltage of the railway power supply line reaching an upper limit of a target range, the power conversion controlling circuitry controls the power converter to start power conversion by the power converter.

6. The station building auxiliary power source device according to claim 1, wherein
when the power converter is stopped, the power conversion controlling circuitry determines whether the voltage of the railway power supply line is on an upward trend, and upon determining that the voltage of the railway power supply line is on an upward trend, controls the power converter to start power conversion by the power converter.

7. The station building auxiliary power source device according to claim 1, further comprising:
supply amount determining circuitry to obtain, from an amount of electric power flowing between the power substation and the station building equipment, an external supply amount that is an amount of electric power supplied to the surrounding equipment when the output power of the power converter is larger than the power consumption of the station building equipment.

8. The station building auxiliary power source device according to claim 1, further comprising:
distribution ratio determining circuitry to determine a distribution ratio for distribution of the regenerated electric power to each of the station building equipment and the surrounding equipment, wherein
the power converter includes
a station building conversion circuit to convert the regenerated electric power into electric power for supply to the station building equipment in accordance with the distribution ratio, and supply the converted electric power to the station building equipment, and
a surrounding conversion circuit to convert the regenerated electric power into electric power for supply to the surrounding equipment in accordance with the distribution ratio, and supply the converted electric power to the surrounding equipment.

9. The station building auxiliary power source device according to claim 8, wherein
the distribution ratio determining circuitry determines the distribution ratio based on the power consumption of the station building equipment and a power consumption of the surrounding equipment.

10. The station building auxiliary power source device according to claim 8, further comprising:
supply amount determining circuitry to obtain, from an output power value of the surrounding conversion circuit, an individual supply amount that is an amount of electric power supplied to the surrounding equipment.

11. An electric power supply system, comprising:
a station building auxiliary power source device connected to a railway power supply line connecting, to an electric railway vehicle, a railway substation to supply electric power to the electric railway vehicle and an equipment power supply line connecting a power substation to station building equipment and surrounding equipment, the station building equipment being arranged in a station building and being to consume electric power, the surrounding equipment being arranged outside the station building and being to consume electric power, the power substation being to supply electric power to the station building equipment and the surrounding equipment; and
a power meter to measure an amount of electric power flowing between the power substation and the station building equipment, wherein
the station building auxiliary power source device includes
a power converter to convert regenerated electric power supplied from the electric railway vehicle via the railway power supply line into electric power for supply to the station building equipment and the surrounding equipment, and output the converted electric power, and
power conversion controlling circuitry to monitor a voltage of the railway power supply line and control the power converter in accordance with the voltage of the railway power supply line, and
when an output power of the power converter is larger than a power consumption of the station building equipment, the output power of the power converter is supplied to the station building equipment and the surrounding equipment via the equipment power supply line, and when the output power of the power converter is equal to or smaller than the power consumption of the station building equipment, the output power of the power converter is supplied to the station building equipment via the equipment power supply line.

12. The electric power supply system according to claim 11, wherein
the station building auxiliary power source device further includes supply amount determining circuitry to obtain, from a measurement value of the power meter, an external supply amount that is an amount of electric power supplied to the surrounding equipment when the output power of the power converter is larger than the power consumption of the station building equipment.

13. An electric power supply system, comprising:
station building auxiliary power source devices connected to a railway power supply line connecting, to an electric railway vehicle, a railway substation to supply electric power to the electric railway vehicle and equipment power supply lines each connecting a power substation to station building equipment or surrounding equipment, the station building equipment being arranged in a station building and being to consume electric power, the surrounding equipment being arranged outside the station building and being to consume electric power, the power substation being to supply electric power to the station building equipment and the surrounding equipment, wherein
each of the station building auxiliary power source devices includes
a power converter to convert regenerated electric power supplied from the electric railway vehicle via the railway power supply line into electric power for supply to the station building equipment or the surrounding equipment, and output the converted electric power, and
power conversion controlling circuitry to monitor a voltage of the railway power supply line and control the power converter in accordance with the voltage of the railway power supply line.

14. The electric power supply system according to claim 13, wherein
a station building auxiliary power source device of the station building auxiliary power source devices that is connected to the equipment power supply line connecting the power substation to the station building equipment includes
distribution ratio determining circuitry to determine a distribution ratio for distribution of the regenerated electric power to each of the station building equipment and the surrounding equipment, and
a station building conversion circuit to convert the regenerated electric power into electric power for supply to the station building equipment in accordance with the distribution ratio, and supply the converted electric power to the station building equipment, and
a station building auxiliary power source device of the station building auxiliary power source devices that is connected to the equipment power supply line connecting the power substation to the surrounding equipment includes a surrounding conversion circuit to convert the regenerated electric power into electric power for supply to the surrounding equipment in accordance with the distribution ratio, and supply the converted electric power to the surrounding equipment.

15. The electric power supply system according to claim 13, wherein
a station building auxiliary power source device of the station building auxiliary power source devices that is connected to the equipment power supply line connecting the power substation to the station building equipment includes a distribution ratio determining circuitry to determine a distribution ratio for distribution of the regenerated electric power to each of the station building equipment and the surrounding equipment,
each of the station building auxiliary power source devices is connected to the railway power supply line, and
the power conversion controlling circuitry included in each of the station building auxiliary power source devices controls the power converter in accordance with the distribution ratio.

16. The electric power supply system according to claim 13, further comprising:
power meters each to measure an amount of electric power flowing between the power substation and the station building equipment or the surrounding equipment, wherein
at least one of the station building auxiliary power source devices further includes fall supply amount determining circuitry to obtain, from measurement values of the power meters, for each surrounding equipment, an individual supply amount that is an amount of electric power supplied to the surrounding equipment.

17. The electric power supply system according to claim 16, further comprising:
an output device to acquire the individual supply amount obtained by the supply amount determining circuitry and display the acquired individual supply amount or transmit the acquired individual supply amount to an external device.
